(19) United States
(12) Patent Application Publication
(10) Pub. No.: US 2022/0219934 A1
(43) Pub. Date: Jul. 14, 2022

(54) PRINT MEDIA HANDLING

(71) Applicant: Hewlett-Packard Development Company, L.P., Spring, TX (US)

(72) Inventor: Shahar Katabi, Ness Ziona (IL)

(73) Assignee: Hewlett-Packard Development Company, L.P., Spring, TX (US)

(21) Appl. No.: 17/614,013

(22) PCT Filed: Sep. 18, 2019
(86) PCT No.: PCT/US2019/051721

§ 371 Date: Nov. 24, 2021

(51) Int. Cl. B65H 31/26; B41J 13/10

(52) U.S. Cl. CPC B65H 31/26; B41J 13/106; B65H 2801/06; B65H 2404/64; B65H 2301/4212

(57) ABSTRACT

Example implementations relate to a print media handling apparatus comprising a media tray to support a stack of print media and to receive an incoming print media to be added to the stack of print media and a pusher to position the incoming print media onto the stack of print media by applying pressure transverse to the movement direction of the incoming print media proximal to a leading edge of the incoming print media.

### BACKGROUND

Many types of printing devices are known, and commonly used, and various printing technologies exist with which various sizes of printing media can be used.

Printing apparatuses are widely used in a variety of environments including in offices and industry. Further to this, a wide variety of print media are known, including paper, coated paper, and 3D print media. Various different sizes of print media are also known.

### BRIEF INTRODUCTION OF THE DRAWINGS

Examples of the disclosure are further described hereinafter with reference to the accompanying drawings, in which:

FIG. 1 shows a side view of an example of a pusher;

FIG. 2 shows a front view of an example of a pusher;

FIG. 3 shows an example of a pusher positioned above a stack of print media;

FIG. 4 shows another example of a pusher positioned above a stack of print media forming part of a printer including a print head;

FIG. 5 shows an example of a pusher pushing incoming print media onto a stack of print media;

FIG. 6 shows a front view of an example of a holder;

FIG. 7 shows a side view of an example of a holder;

FIG. 8 shows a perspective view of an example of a holder;

FIG. 9 shows an example of a pusher attached to a holder;

FIG. 10 shows an example of a pusher attached to a holder positioned above a stack of print media; and

FIG. 11 shows an example of a pusher attached to a holder pushing incoming print media onto a stack of print media.

### DETAILED DESCRIPTION

Examples provide a print media handling apparatus for stacking print media in a media tray of a printing apparatus. The printing apparatus may be used to print multiple print jobs consecutively and may therefore stack multiple print media in a media tray. The printing apparatus may therefore position print media in the media tray to create a stack of print media. The apparatus may be configured such that the incoming print media is positioned in the media tray.

Further examples provide an apparatus for stacking multiple sizes of print media in a media tray of a printing apparatus. The printing apparatus may be used to print using multiple different sizes of print media and print jobs may be queued such that consecutive print jobs use different sizes of print media. The printing apparatus may therefore be used to print one print job of one size of print media, followed immediately by a second print job of a second, different, size of print media, or may be used to print a single print job that uses multiple sizes of print media. The printing apparatus may then stack multiple sizes of print media in a single media tray of the printing apparatus.

It will be appreciated that a first print media of a print job may be a first size, and a second print media of a print job, or a print media of a consecutive print job, may be a second size that is larger or longer than the size of the first print media.

In this scenario, a larger second print media may be stacked on top of a stack of smaller, first print media in a media tray of the printing apparatus. Where larger print media are stacked on top of smaller print media it is possible for the larger print media to be misaligned on the stack.

A printing apparatus may include a print media handling apparatus with which to stack incoming print media onto the media tray. The apparatus may be configured such that incoming print media is positioned on the media tray.

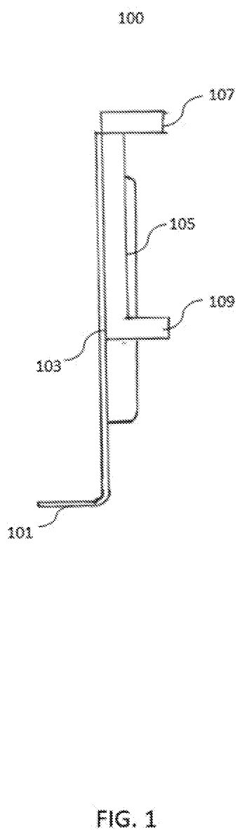

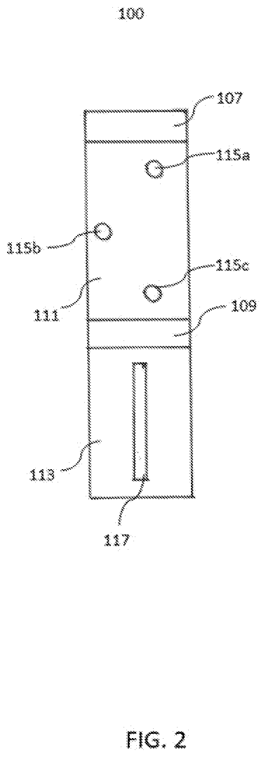

FIGS. 1 and 2 show an example of a pusher 100 forming part of a print media handling apparatus of a printing apparatus. The pusher 100 is used to push downwards on incoming print media to position the incoming print media on the stack of print media already supported by the media tray. The pusher may push downwards on the incoming print media once the incoming print media has already been decelerated and rendered stationary in the appropriate position in or on a media tray. The pusher 100 is arranged to apply pressure to the incoming print media to compress the incoming print media and the stack of print media supported by the media tray to position the incoming print media on the stack of print media.

FIG. 1 shows a side view of an example pusher 100. The pusher 100 comprises a foot 101, that is arranged to apply a pressure transverse to the movement of the incoming print media, proximal to the leading edge of the incoming print media and an upright member 103 which forms an L-shape with the foot 101. The foot 101 may comprise a flat part of the pusher 100 which is parallel to the plane of print media in the media tray. The upright member 103 may be orthogonal to the plane of print media in the media tray.

The foot 101 and upright member 103 are attached to a coupling apparatus 105 provided to attach the pusher 100 to a translation apparatus of the printing apparatus which is arranged to move the pusher 100 such that it is positioned proximal to the leading edge of the incoming print media.

The coupling apparatus 105 may be attached to the upright member 103, for instance via one or more screws. The screws may be passed through openings 115a, 115b, 115c in the coupling apparatus, as illustrated in the front view of the pusher 100 depicted in FIG. 2.

The coupling apparatus 105 includes an upper arm 107 and a lower arm 109 which can be used to further support the attachment of the pusher 100 to the translation apparatus of the printing apparatus. The upper arm 107 and the lower arm 109 may be provided with openings through which screws pass, to facilitate further attachment of the coupling apparatus 105 to the translation apparatus of the printing apparatus, although this is not shown. Alternatively, no openings may be provided.

The coupling apparatus 105 is attached to the upright member 103 such that the upper arm 107 and the lower arm 109 face in the opposite direction to the foot 101.

Alternatively, the coupling apparatus 105 may be aligned such that the upper arm 107 and the lower arm 109 face in the same direction as the foot 101.

An upper portion 111 of the pusher 100, as illustrated by FIG. 2, provides three openings 115a, 115b, 115c, although it will be appreciated that any number of openings could be used.

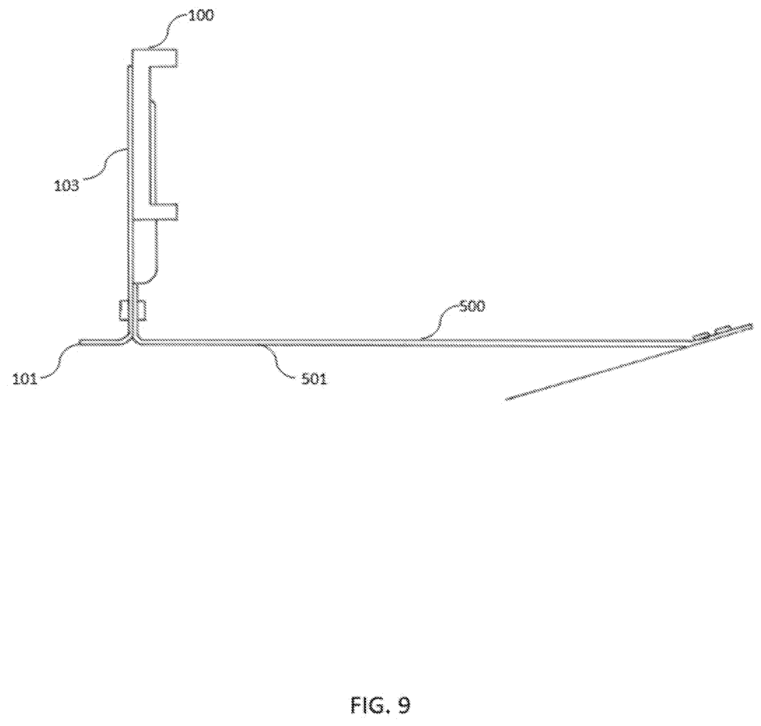

A lower portion 113 of the pusher 100, positioned below the lower arm 109 of the coupling apparatus 105, may include an elongated rectangular opening 117. The elongated rectangular opening 117 is positioned in the centre of the lower portion 113 of the pusher and extends along the length of the lower portion 113 of the pusher. The elongated rectangular opening 117 passes through the upright member 103 of the pusher 100. The elongated rectangular opening 117 may be used to attach the pusher 100 to a holder, as described with reference to FIG. 9.

The elongated rectangular opening 117 is merely an example and it will be appreciated that a different shape, or multiple openings, could be used. Alternatively, no openings may be provided at all if the pusher is not attached to a holder.

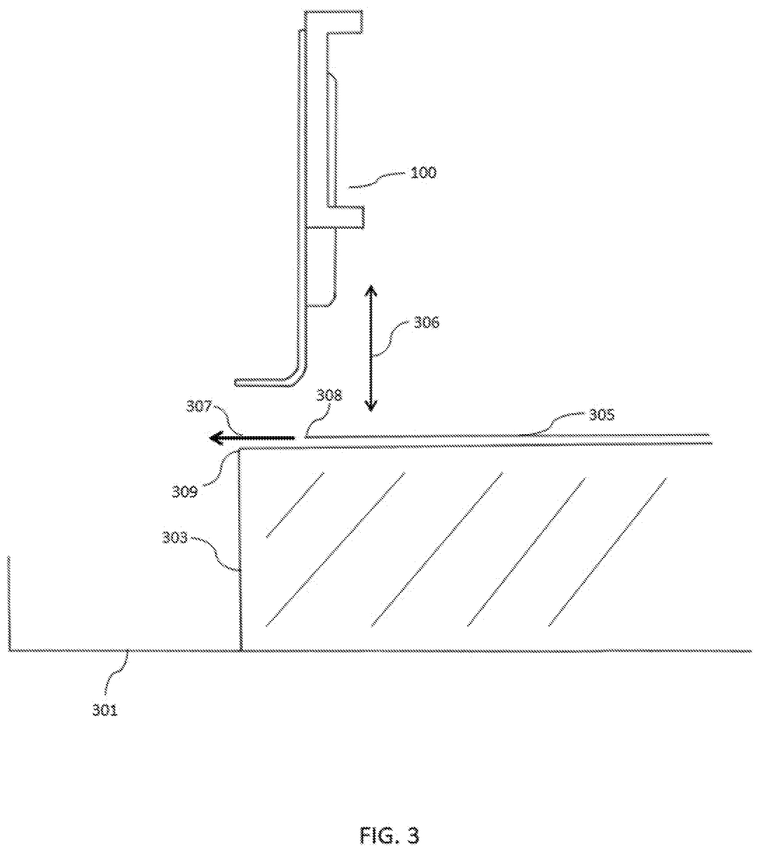

FIG. 3 shows a further example of the pusher 100 as described with reference to FIGS. 1 and 2 in an initial position above a media tray 301, a stack of print media 303 supported by the media tray 301, and an incoming print media 305.

The media tray 301 supports the stack of print media 303 that has already been positioned on the media tray 301 by the pusher 100.

The media tray 301 may be provided such that it can accommodate multiple sizes of print media. For instance, FIG. 3 shows the media tray 301 extending beyond the leading edge 308 of the stack of print media 303; the media tray 301 may therefore accommodate print media larger than the print media in the stack of print media 303 shown.

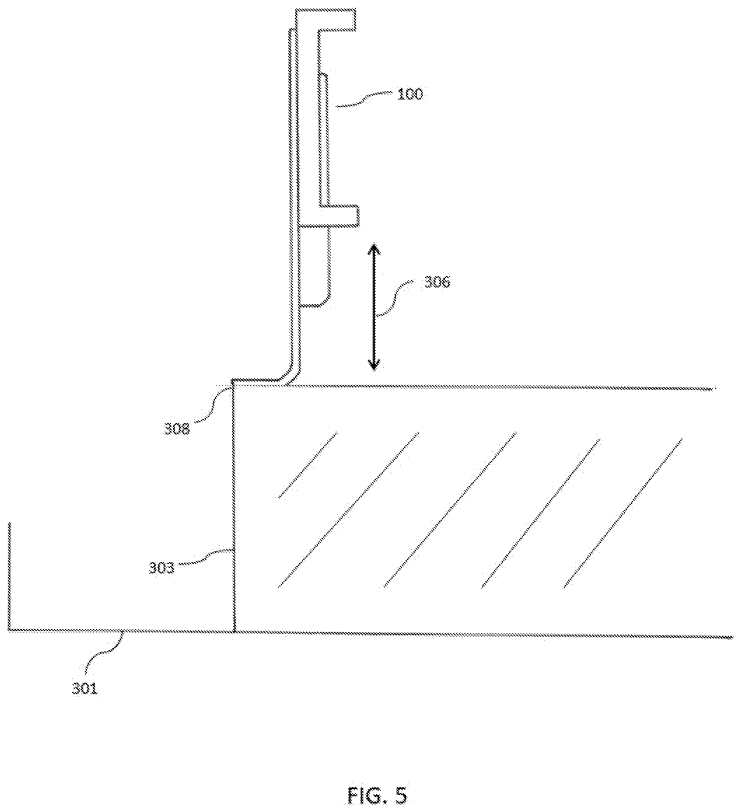

An incoming print media 305 is shown moving (along arrow 307) above the media tray 301 and the stack of print media 303. The incoming print media 305 is fed onto the stack of print media 305 supported by the media tray 301 from a different part of the printing apparatus. The incoming print media 305 moves across the stack of print media 303 until the leading edge 308 of the incoming print media 305 is proximal to the leading edge 309 of the stack of print media 303 already supported by the media tray 301. The pusher 100 is configured to then position the incoming print media 305 onto the stack of print media 303 supported by the media tray 301, as shown by FIG. 5. To achieve this the pusher 100 is configured to move normally to the incoming print media 305 as indicated by arrow 306.

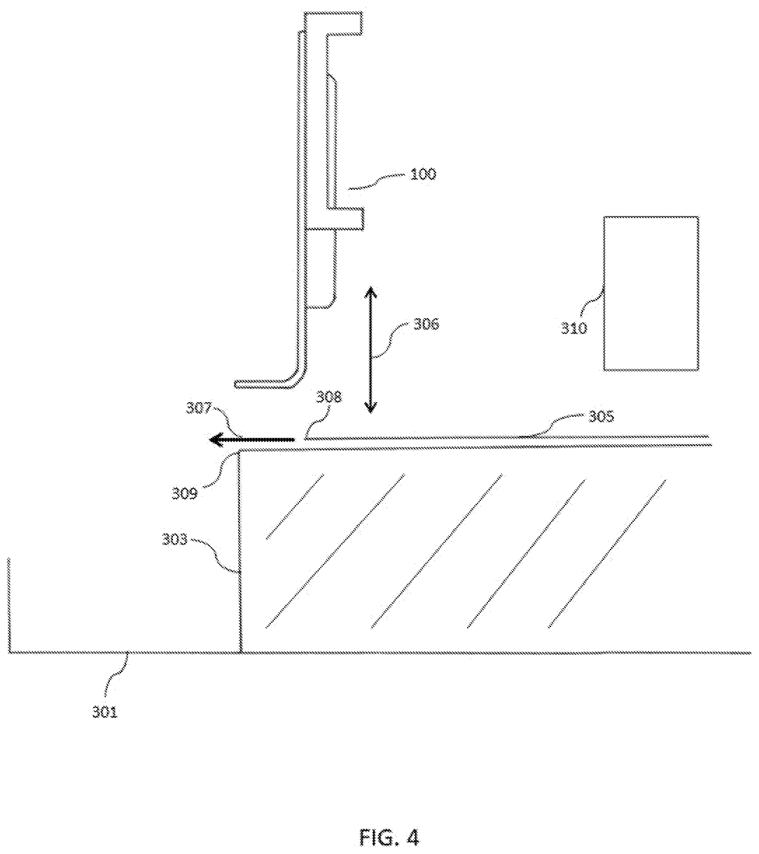

As shown by FIG. 4, a printer includes the pusher 100 described with reference to FIGS. 1 to 3 and also includes a print head 310 arranged to print onto the incoming print media 305 prior to it passing to the media tray 301. The pusher serves to position the incoming print media onto the stack of print media in the media tray, as for the previous examples. Prior to the print media reaching the media tray, the print head applies a desired print pattern to the print media. It will be understood that the print head may be arranged at any suitable location relative to the media tray and the relative location of FIG. 4 is not to be understood as limiting.

FIG. 5 shows a further example of the pusher 100, as described with reference to FIGS. 1 and 2, as it pushes on the incoming print media 305. The pusher 100, particularly the foot 101, pushes on the incoming print media 305, thereby applying pressure to the incoming print media 305 to position it on the stack of print media 303 supported by the media tray 301. The applied pressure serves to compress the incoming print media 305 onto the stack of print media 303. It has been found that this serves to reduce subsequent movement of the incoming print media 305 (now the topmost sheet of stack 303) when a subsequent incoming print media passes over the top of the stack 303.

The foot 101 of the pusher 100 is provided such that it applies pressure transverse to the direction of movement of the incoming print media 305 (along arrow 306), pushing downward on the incoming print media 305 to position it on the stack of print media 303 and compressing the stack of print media 303.

The pusher 100 is positioned such that it is aligned proximal to the leading edge 308 of the incoming print media 305 (now the topmost sheet of the stack 303). The pusher 100 may initially be positioned in a first position above a first surface of the incoming print media 305 as the incoming print media 305 moves into place over the stack of print media 303 supported by the media tray 301. The pusher 100 may subsequently travel along an axis transverse to the direction of movement of the incoming print media 305 (along arrow 306) such that the foot 101 of the pusher applies pressure transverse to the movement of the incoming print media 305 to the incoming print media 305.

The pressure applied by the foot 101 of the pusher 100 thereby positions the incoming print media 305 onto the stack of print media 303 supported by the media tray 301.

In further examples, as described below, the incoming print media 305 may be larger than the print media in the stack of print media 303 supported by the media tray 301. Therefore, a further application of pressure in addition to the pressure applied by the pusher 100 may therefore be needed to prevent the stack of print media 303 from being misaligned by incoming print media 305.

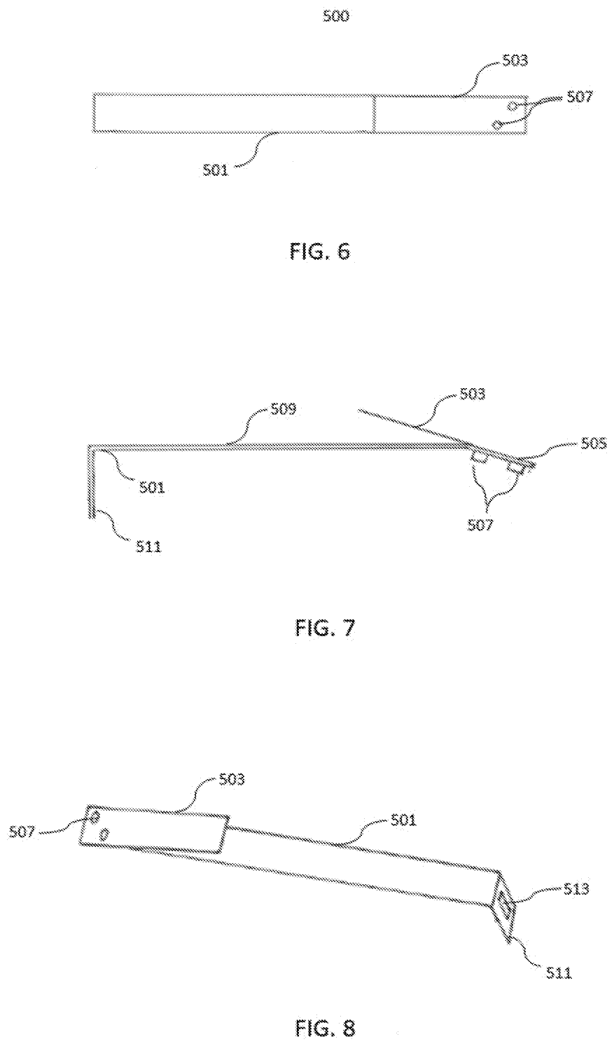

An example of a holder that may be attached to the pusher 100 is described below with reference to FIGS. 6, 7, and 8.

FIGS. 6, 7, and 8 illustrate the holder 500 which may comprise two parts; an L-shaped bracket 501, and a resiliently deformable member 503 arranged to be in contact with incoming print media.

FIG. 6 shows a front view of a holder 500. The holder 500 comprises a main body 509 and the sprung member 503 which are attached via an attachment portion 505 (shown in FIG. 7) of the main body 509.

The main body as illustrated by FIG. 6 is an example implementation of a bar.

The attachment portion 505 of the main body 509 may be provided with two openings through which screws or bolts 507 pass. A corresponding portion of the resiliently deformable member 503 may also be provided with corresponding openings through which the screws or bolts 507 may be passed, to couple the main body 501 and the resiliently deformable member 503.

Alternatively, the resiliently deformable member 503 and the main body 501 may be formed of a single piece of material.

FIG. 7 shows a side view of the holder 500 illustrated by FIG. 6. The holder 500, as illustrated by FIG. 7, comprises an L-shaped bracket 501 comprising the main body 509 and a portion 511 extending transverse to the main body 509. The bracket 501 couples to the foot 101 of the pusher 100 as described above. For instance, the bracket 501 may include an opening 513 corresponding to opening 117 in the pusher 100, as illustrated in FIG. 8.

The resiliently deformable member 503 extends from the main body 509 towards incoming print media such that it may press the incoming print media onto a stack of print media supported by a media tray. The resiliently deformable member 503 may be resiliently biased such that pressure is applied to the incoming print media transverse to the direction of movement of the incoming print media. The resiliently deformable member 503 may be a leaf spring wherein an end of the leaf spring may be distal from its attachment to the main body 501.

FIG. 8 shows a perspective view of the holder 500 illustrated by FIGS. 6 and 7. The holder 500 is arranged to hold the incoming print media in place, aiding in positioning the incoming print media on the stack of print media supported by the media tray.

FIG. 9 shows a side view of the pusher 100 illustrated by FIGS. 1 to 5 attached to the holder 500 illustrated by FIGS. 6 to 8. The pusher 100 and the holder 500 are connected such that the foot 101 of the pusher 100 and the bracket 501 of the holder extend in opposite directions along an axis transverse to that of the upright member 103 of the pusher.

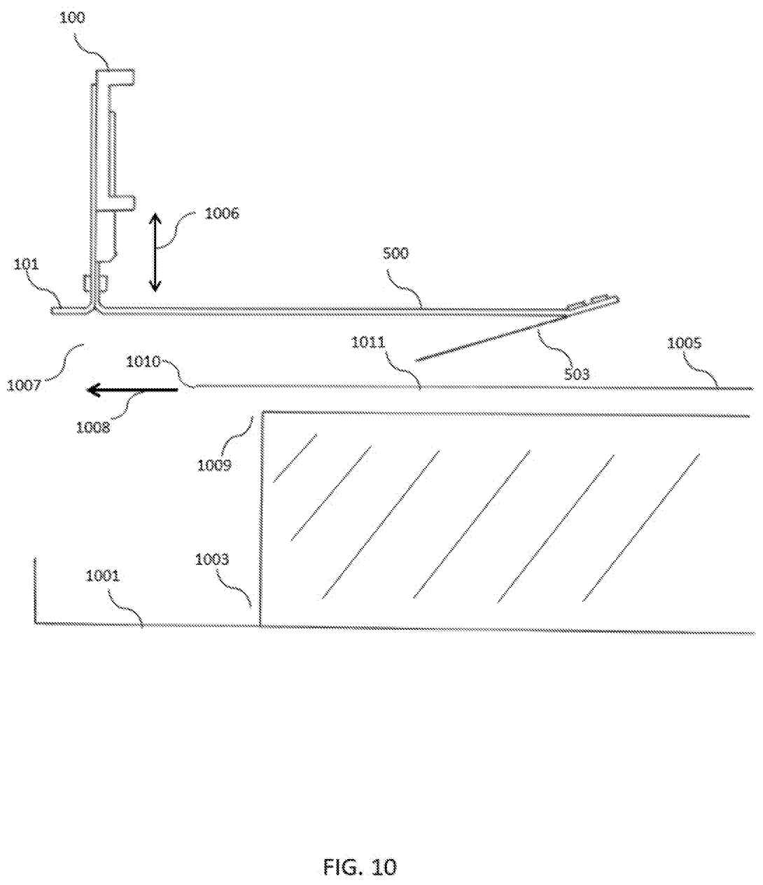

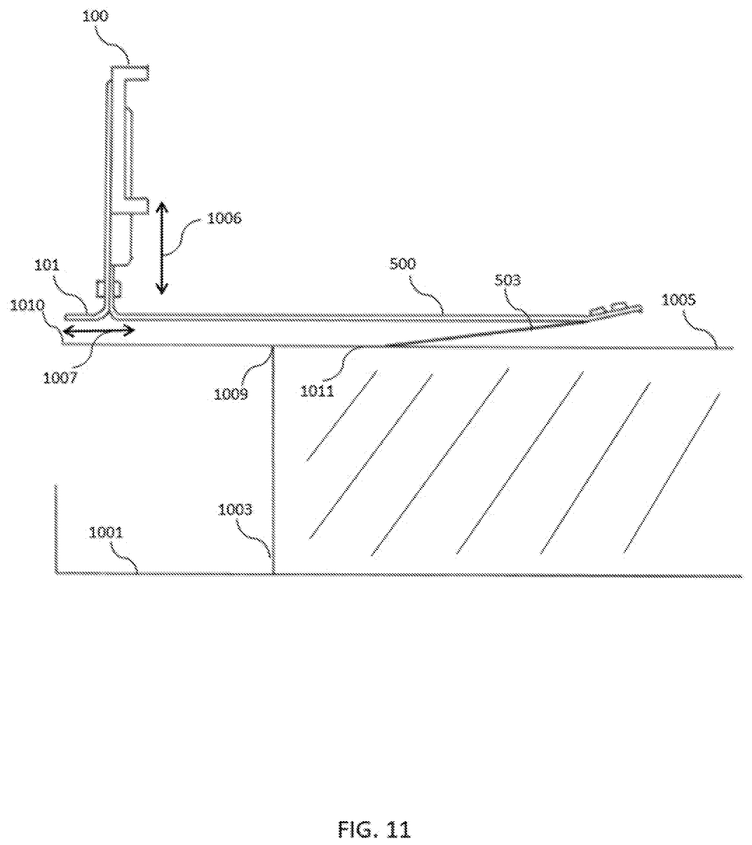

The holder 500 may extend transverse to the upright member 103 of the pusher 100 over a mid-portion of a stack of print media, as shown in FIGS. 10 and 11. A portion of the holder 500 that is positioned over the mid-portion of the stack of print media, as shown in FIG. 10, may extend towards the stack of print media such that it may press the incoming print media onto the stack of print media. The holder 500 may extend transverse from the pusher 100 such that it slopes away from an end of the pusher 100 that contacts incoming print media, as illustrated by FIGS. 10 and 11.

The mid-portion of the stack of print media may be any area of the surface of the stack of print media between the leading edge and the ending edge of the stack of print media. For example, with regard to FIGS. 10 and 11, the mid-portion is shown as towards a mid-point of a length of the incoming print media when it is in position on the stack of print media.

FIG. 10 shows an example of the pusher 100 and holder 500, as described with reference to FIG. 9, in an initial position above the media tray 1001, the stack of print media 1003 supported by the media tray 1001, and the incoming print media 1005.

The media tray 1001 is provided such that it supports the stack of print media 1003 which has already been positioned on the media tray 1001 by the pusher 100 and the holder 500.

The media tray 1001 may be provided such that it can accommodate multiple sizes of print media. For instance, FIG. 10 shows the media tray 1001 extending beyond the leading edge 1009 of the stack of print media 1003; the media tray 1001 may therefore accommodate print media larger than the print media in the stack of print media 1003 shown.

The incoming print media 1005 is shown moving above the media tray 1001 and the stack of print media 1003 (along arrow 1008). The incoming print media 1005 is fed onto the stack of print media 1003 supported by the media tray 1001 from a different part of the printing apparatus. The incoming print media 1005 moves across the stack of print media 1003 (along arrow 1008) until the leading edge 1010 of the incoming print media 1005 is beyond the leading edge 1009 of the stack of print media 1003 already supported by the media tray 1001 and the entire length of the incoming print media 1005 has been fed onto the media tray 1001 (as shown by FIG. 11). The pusher 100 and the holder 500 are configured to position the incoming print media 1005 onto the stack of print media 1003 supported by the media tray 1001, as shown by FIG. 11.

FIG. 11 shows an example of the pusher 100 and the holder 500 as described with reference to FIGS. 9 and 10 as they position the incoming print media 1005. The pusher 100 pushes on the incoming print media 1005, while the holder 500 holds the incoming print media in place. Thereby, both the pusher 100 and the holder 500 apply pressure to the incoming print media 1005 to position it on the stack of print media 1003 supported by the media tray 1001.

The foot 101 of the pusher 100 is provided such that it applies pressure transverse to the direction of movement of the incoming print media 1005, pushing downward on the incoming print media 1005 to position it on the stack of print media 1003 and compressing the stack of print media 1003.

The resiliently deformable member 503 of the holder 500 is provided such that it extends onto a mid-portion of the incoming print media 1005, applying pressure transverse to the direction of movement of the incoming print media 1005 (along arrow 1006). This pressure holds the incoming print media 1005 in place as the pusher 100 pushes the incoming print media 1005 into position on the stack of print media 1003 and compresses the stack of print media 1003 supported by the media tray 1001. As the pusher and holder move downwards along arrow 1006 the resiliently deformable member 503 is compressed against bracket 501 as it bears against the incoming print media 1005 and the stack of print media 1003.

The pusher 100 is positioned such that it is aligned proximal to the leading edge 1010 of the incoming print media 1005. The holder 500 is positioned such that it extends onto a mid-portion 1011 of the stack of print media 1003. The pusher 100 and the holder 500 may initially be positioned in a first position above a first surface of the incoming print media 1005 as the incoming print media 1005 moves into place over the stack of print media 1003 supported by the media tray 1001. The pusher 100 may subsequently travel along an axis transverse to the direction of movement of the incoming print media 1005 (along arrow 1006) such that the foot 101 of the pusher and the resiliently deformable member 503 of the holder 500 apply pressure transverse to the movement of the incoming print media 1005 to the incoming print media 1005.

The pressure applied by the foot 101 of the pusher 100 and the resiliently deformable member 503 of the holder 500 thereby positions the incoming print media 1005 onto the stack of print media 1003 supported by the media tray 1001.

The pusher 100 and the holder 500 may compress the stack of print media 1003 and the positioned incoming print media 1005 such that newly incoming print media does not cause the print media of the stack of print media 1003 to be dragged out of alignment with the rest of the stack.

The pusher 100 and the holder 500 are provided such that they move according to the size of the incoming print media 1005. To achieve this, the pusher 100 and the holder 500 are configured to move parallel to the plane of the stack of print media 1003, as indicated by arrow 1007, such that the foot 101 of the pusher 100 is positioned proximal to the leading edge 1010 of the incoming print media 1005 and the resiliently deformable member 503 of the holder 500 extends onto a mid-portion 1011 of the stack of print media 1003.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants that fall within the scope of the claims.

Example implementations can be realised according to the following clauses:

Clause 1: A print apparatus comprising a media tray to support a stack of print media and to receive an incoming print media to be added to the stack of print media and a pusher to position the incoming print media onto the stack of print media by applying pressure transverse to a movement direction of the incoming print media proximal to a leading edge of the incoming print media.

Clause 2: The print media handling apparatus of clause 1, wherein the pusher is mounted relative to the media tray to travel along a first axis transverse to a movement direction of the incoming print media and to bear against a portion of the incoming print media proximal to its leading edge once the incoming print media is positioned on the stack of print media.

Clause 3: The print media handling apparatus of either of clauses 1 and 2, wherein the pusher is mounted relative the media tray to travel along a second axis parallel to the movement direction of the incoming print media to be positioned such that it is proximal to the leading edge of the incoming print media, according to the size of the incoming print media.

Clause 4: The print media handling apparatus of any of clauses 1 to 3, wherein the first axis is orthogonal to the movement direction of the incoming print media and the second axis is parallel to the movement direction of the incoming print media.

Clause 5: The print media handling apparatus of the preceding clauses, further comprising a holder coupled to the pusher; the holder being arranged to apply pressure to a mid-portion of the incoming print media.

Clause 6: The print media handling apparatus of clause 5, wherein at least a part of the holder is resiliently biased, and the holder extends from the pusher over the leading edge of the incoming print media to apply pressure transverse to the movement of the incoming print media to the mid-portion of the incoming print media, wherein the pressure applied by the holder is such that the stack of print media is compressed.

Clause 7: The print media handling apparatus of either of clauses 5 and 6, wherein the holder comprises a spring member to apply pressure to the mid-portion of the incoming print media.

Clause 8: The print media handling apparatus of any of clauses 5 to 7, wherein the holder comprises a bar and the spring member comprises a leaf spring extending from the bar towards the stack of print media.

Clause 9: The print media handling apparatus of clause 8, wherein the leaf spring faces the incoming print media and extends from the bar in the direction of motion of the incoming print media and wherein the leaf spring is in contact with the incoming print media.

Clause 10: The print media handling apparatus of either clauses 8 and 9, wherein the bar extends from the pusher such that it slopes away from an end of the pusher which contacts the incoming print media.

Clause 11: The print media handling apparatus of clauses 8 to 10, wherein an end of the leaf spring distal from its attachment to the bar is arranged to contact the incoming print media.

Clause 12: The print media handling apparatus of any of clauses 5 to 11, wherein the holder is detachably coupled to the pusher.

Clause 13: The print media handling apparatus of the preceding clauses, comprising two or more pushers.

Clause 14: A printer comprising a print media handling apparatus according to any of the preceding clauses, and a print head to print onto a print media prior to the print media passing to the media tray.

Clause 15: A printer comprising: a print apparatus comprising: a media tray to support a stack of print media and to receive an incoming print media to be stacked upon the stack of print media; and a pusher to compress a leading edge portion of the incoming print media onto the stack of print media by moving in a direction orthogonal to the a movement direction of the incoming print media to contact a portion of the incoming print media proximal to a leading edge of the incoming print media; and a print head to print onto a print media prior to the print media passing to the media tray.

Clause 16: A pusher comprising: an elongate member to attach to a translation mechanism of a print apparatus; and a foot at a first end of the elongate member to contact print media in a media tray of a print apparatus to compress an incoming print media onto a stack of print media.

1. A print apparatus comprising:
a media tray to support a stack of print media and to receive an incoming print media to be added to the stack of print media; and
a pusher to position the incoming print media onto the stack of print media by applying pressure transverse to a movement direction of the incoming print media proximal to a leading edge of the incoming print media.

2. The print apparatus of claim 1, wherein the pusher is mounted relative to the media tray to travel along a first axis transverse to a movement direction of the incoming print media and to bear against a portion of the incoming print media proximal to its leading edge once the incoming print media is positioned on the stack of print media.

3. The print apparatus of claim 2, wherein the pusher is mounted relative the media tray to travel along a second axis parallel to the movement direction of the incoming print media to be positioned such that it is proximal to the leading edge of the incoming print media, according to the size of the incoming print media.

4. The print apparatus of claim 3, wherein the first axis is orthogonal to the movement direction of the incoming print media and the second axis is parallel to the movement direction of the incoming print media.

5. The print apparatus of claim 1, further comprising a holder coupled to the pusher; the holder being arranged to apply pressure to a mid-portion of the incoming print media.

6. The print apparatus of claim 5, wherein at least a part of the holder is resiliently biased, and the holder extends from the pusher over the leading edge of the incoming print media to apply pressure transverse to the movement of the incoming print media to the mid-portion of the incoming print media;
wherein the pressure applied by the holder is such that the stack of print media is compressed.

7. The print apparatus of claim 6, wherein the holder comprises a spring member to apply pressure to the mid-portion of the incoming print media.

8. The print apparatus of claim 7, wherein the holder comprises a bar and the spring member comprises a leaf spring extending from a bar towards the stack of print media.

9. The print apparatus of claim 8, wherein the leaf spring faces the incoming print media and extends from the bar in the direction of motion of the incoming print media; and
wherein the leaf spring is in contact with the incoming print media.

10. The print apparatus of claim 8, wherein the bar extends from the pusher such that it slopes away from an end of the pusher which contacts the incoming print media.

11. The print apparatus of claim 10, wherein an end of the leaf spring distal from its attachment to the bar is arranged to contact the incoming print media.

12. The print apparatus of claim 5, wherein the holder is detachably coupled to the pusher.

13. The print apparatus of claim 1, comprising two or more pushers.

14. A printer comprising:
a print apparatus comprising:
a media tray to support a stack of print media and to receive an incoming print media to be stacked upon the stack of print media; and
a pusher to compress a leading edge portion of the incoming print media onto the stack of print media by moving in a direction orthogonal to a movement direction of the incoming print media to contact a portion of the incoming print media proximal to a leading edge of the incoming print media; and
a print head to print onto a print media prior to the print media passing to the media tray.

15. A pusher comprising:
an elongate member to attach to a translation mechanism of a print apparatus; and
a foot at a first end of the elongate member to contact print media in a media tray of a print apparatus to compress an incoming print media onto a stack of print media.
